(19) United States
(12) Patent Application Publication
(10) Pub. No.: US 2004/0149142 A1
(43) Pub. Date: Aug. 5, 2004

(54) Bakeware having a textured surface

(76) Inventor: William A. Groll, McMurray, PA (US)

Correspondence Address: Frederick B. Ziesenheim, Webb Ziesenheim Logsdon Orkin & Hanson, P.C., 700 Koppers Building, 436 Seventh Avenue, Pittsburgh, PA, 15219-1818, US

(21) Appl. No.: 10/712,941

(22) Filed: Nov. 13, 2003

Related U.S. Application Data
(60) Provisional application No. 60/443,624, filed on Jan. 30, 2003.

(51) Int. Cl. A47J 43/18

(52) U.S. Cl. 99/426

(57) ABSTRACT

Bakeware having an embossed textured pattern formed on the food-contacting surface and on the exterior surface. In the preferred embodiment, the textured pattern on the food-contacting surface is made up of a plurality of spaced-apart raised diamond-shaped surfaces separated by depressed grooves. The textured pattern of the exterior surface consists of a plurality of spaced-apart depressed diamond-shaped surfaces separated by raised ridges.

### CROSS-REFERENCE TO RELATION APPLICATION

This application claims the benefit of U.S. Provisional Application No. 60/443,624 filed Jan. 30, 2003, entitled “Bakeware Having a Textured Surface”.

### BACKGROUND OF THE INVENTION

1. Field of the Invention

The present invention relates generally to food preparation utensils and, more particularly, to bakeware having a textured surface.

2. Description of Related Art

Applying a texture to a food-contacting surface of cookware for enhanced stick resistance and for improved heating or cooking characteristics is known in the art. For example, U.S. Pat. No. 2,618,258 to Kroyer discloses a frying pan 1 or other utensil wherein the bottom frying surface 2 has an undulating configuration and of reduced heat conductivity. U.S. Pat. No. 5,628,426 to Doyle et al. also discloses a frying pan 10 in which the food-contacting surface has a plurality of raised “dots” 14. In both the above noted patents, only the bottom of the fry pans has a textured surface, whereas the sidewalls are smooth.

Bakeware having irregularly shaped textured surfaces is taught in U.S. Pat. No. 5,351,608 to Muchin et al. and U.S. Pat. No. 6,279,771 to Bryant. More particularly, Muchin et al. discloses a bakeware utensil such as a cookie sheet 10 comprising two separate sheets, an upper sheet 12 and a lower sheet 20. The lower sheet supports the upper sheet by way of detents 22 formed in the lower sheet to provide an insulating air space between the two sheets. A texturized surface is formed on the food contacting surface of the upper sheet comprising generally rounded protrusions 26 of various sizes and crater-like depressions 28. The textures surface is said to provide improved stick resistance, stain and scratch resistance. Muchin et al. discloses a further embodiment comprising a baking sheet 11 having irregularly shaped protrusions 26, depressions 28 with holes 32 formed completely through the sheet 11 to permit air flow therethrough which is said to improve the crispiness of the crust of pizza. Bryant in the '771 patent discloses a vessel 10 having random, pebble grain pattern, textured food contacting surfaces 12, 14 comprising straight, vertically walled raised portions 16 and valleys 18 having an irregular surface shape which is said to be useful for foods like pizza and pies and other foods that lend themselves to cooking or freezing or thawing on a sheet. The above noted patents are incorporated by reference herein

### SUMMARY OF THE INVENTION

Briefly stated, the present invention is directed to bakeware comprising a shaped utensil, such as a cookie sheet, square or round cake pan, bread pan, pie pan, jellyroll pan, utility pan and the like, made from a metal sheet having a regular, straight-sided, geometric pattern, such a, for example, a diamond-shaped pattern, embossed on both the inner and outer surfaces thereof. In a presently preferred embodiment of the present invention, the bakeware is made from type 3003 aluminum alloy sheet having a thickness on the order of 0.063 inch. The aluminum sheet stock for forming the bakeware of the invention is economically manufactured using upper and lower rolls which are embossed with a mating diamond pattern. The embossed upper and lower rolls forcibly engage the smooth aluminum sheet or strip stock and simultaneously impart the desired diamond texture on both sides of the stock material. The corresponding diamond-shaped areas on the outer and inner surfaces of the aluminum sheet are aligned with each other such that the diamond-shaped areas on the inside, food contacting surface protrude outwardly, while the diamond-shaped areas on the outside surface protrude inwardly, with corresponding registry between the individual inside and outside diamonds. In this manner, the cross-sectional thickness of the bakeware remains relatively constant over the width and length of the utensil. This double-sided embossing not only provides an enhanced cosmetic appearance on both inner and outer surfaces, it also provides thermal warp resistance compared to smooth bakeware or the one-sided bakeware textured surfaces of the prior art. The inner and outer textured surfaces also provide non-stick properties, particularly on the inside of the utensil, as well as abrasion and scratch resistance on both sides. The utensil resists marring and scratching even though abrasive cleaning pads are used.

The double-sided textured surface of a regular geometric pattern, such as the diamond shape of the present invention, also provides for easier manufacturing of deep drawn shapes such as cake pans, utility pans, bread pans and jellyroll pans. The double-sided textured surface is easier to draw than a smooth metal sheet because it carries the drawing lubricant in the depressions in the textured surface. The regularly-occurring pattern of the diamond texture also provides uniform drawing characteristics with fewer tool marks on the drawn shape and, hence, less scrap. The double-sided texture of the present invention also provides a peripheral edge around flat bakeware (such as a cookie sheet) which is somewhat blunted and, hence, it is not necessary to perform an edge rollover operation to hide the sharp peripheral edge as is necessary in the prior art.

Cleanup is also easier with the regular geometric surface pattern of the present invention over the random texture patterns of the prior art. In a random surface pattern, sticking food particles may remain hidden behind the irregularly-shaped protrusions which requires scrubbing in all directions, whereas in the present invention food is easily removed merely by rubbing in a direction parallel to the straight lines of the surface pattern.

These as well as other advantages and attributes of the present invention will be apparent when reference is made to the appended drawings, taken with the following detailed description.

### BRIEF DESCRIPTION OF THE DRAWINGS

FIG. 1A is a top plan view of a presently preferred embodiment of a portion of the textured food contacting surface of the bakeware of the present invention;

FIG. 1B is a bottom plan view of a presently preferred embodiment of a portion of the textured exterior surface of the bakeware of FIG. 1A;

FIG. 2A is a fragmented, enlarged view of the food conducting surface depicted in FIG. 1A;

FIG. 2B is a fragmented, enlarged view of the exterior surface depicted in FIG. 1B;

FIG. 3A is a cross-sectional view of the textured bakeware of the present invention taken along section line III-III of FIG. 2A;

FIG. 3B is a fragmented, enlarged isometric perspective view of the food-contacting surface of the bakeware of FIG. 1A;

FIG. 3C is a fragmented, enlarged perspective view of the exterior surface of the bakeware of FIG. 1B;

FIG. 4A is a perspective view of a round cake baking pan in accordance with the present invention;

FIG. 4B is a top plan view of the pan of FIG. 4A;

FIG. 4C is a side elevation view of the pan of FIG. 4A;

FIG. 4E is a bottom plan view of the pan of FIG. 4A;

FIG. 5A is a perspective view of a rectangular utility pan in accordance with the bakeware of the present invention;

FIG. 5B is a top plan view of the rectangular utility pan of FIG. 5A;

FIG. 5C is a side elevation view of the rectangular utility pan of FIG. 5A;

FIG. 5D is an end elevation view of the rectangular utility pan of FIG. 5A;

FIG. 5E is a bottom plan view of the rectangular utility pan of FIG. 5A;

FIG. 6A is a perspective view of a rectangular jellyroll pan in accordance with the present invention;

FIG. 6B is a top plan view of the rectangular jellyroll pan of FIG. 6A;

FIG. 6C is a side elevation view of the rectangular jellyroll pan of FIG. 6A;

FIG. 6D is an end elevation view of the rectangular jellyroll pan of FIG. 6A;

FIG. 6E is a bottom plan view of the rectangular jellyroll pan of FIG. 6A;

FIG. 7A is a perspective view of a square cake pan in accordance with the present invention;

FIG. 7B is a top plan view of the square cake pan of FIG. 7A;

FIG. 7C is a side elevation view of the square cake pan of FIG. 7A;

FIG. 7D is an end elevation view of the square cake pan of FIG. 7A;

FIG. 7E is a bottom plan view of the square cake pan of FIG. 7A;

FIG. 8A is a perspective view of a rectangular cookie sheet in accordance with the present invention;

FIG. 8B is a top plan view of the rectangular cookie sheet of FIG. 8A;

FIG. 8C is a side elevation view of the rectangular cookie sheet of FIG. 8A;

FIG. 8D is an end elevation view of the rectangular cookie sheet of FIG. 8A;

FIG. 8E is a bottom plan view of the rectangular cookie sheet of FIG. 8A; and

FIG. 9 is a fragmented, photographic depiction of anodized bakeware of the present invention showing laser applied marking indicia thereto.

### DETAILED DESCRIPTION OF THE INVENTION

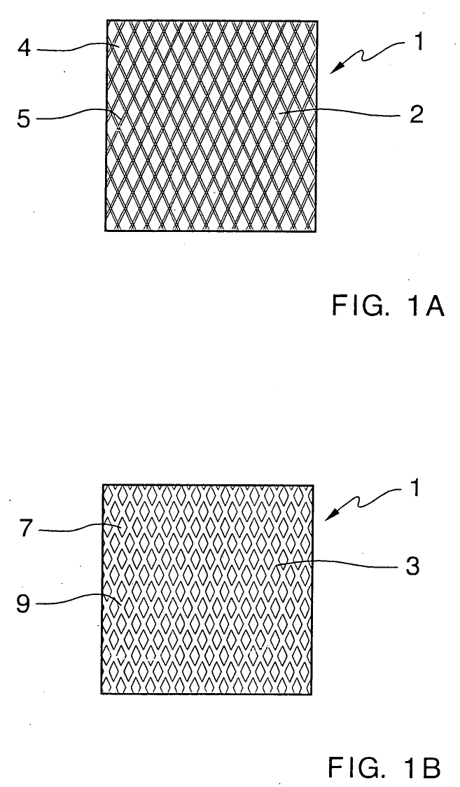

The textured bakeware surface of the present invention, generally identified as element 1 in the drawings will now be described in detail. The bakeware 1 comprises a textured upper or food contacting surface 2 depicted in detail in FIGS. 1A, 2A, 3A and 3B and a textured lower or exterior surface 3 shown in FIGS. 1B, 2B, 3A and 3C. It will be understood that even though not all portions of the upper surface 2 will actually come in physical contact with the food product being baked, nevertheless, the entire upper surface 2 is referred to herein as the “food contacting surface” for ease of expression.

Both the food contacting surface 2 and exterior surface 3 in the presently preferred embodiment of the invention depicted in the drawings are somewhat similar because both surfaces contain a diamond textured surface pattern but, as will be described hereinafter, each of the textured patterns of surfaces 2 and 3 are distinct.

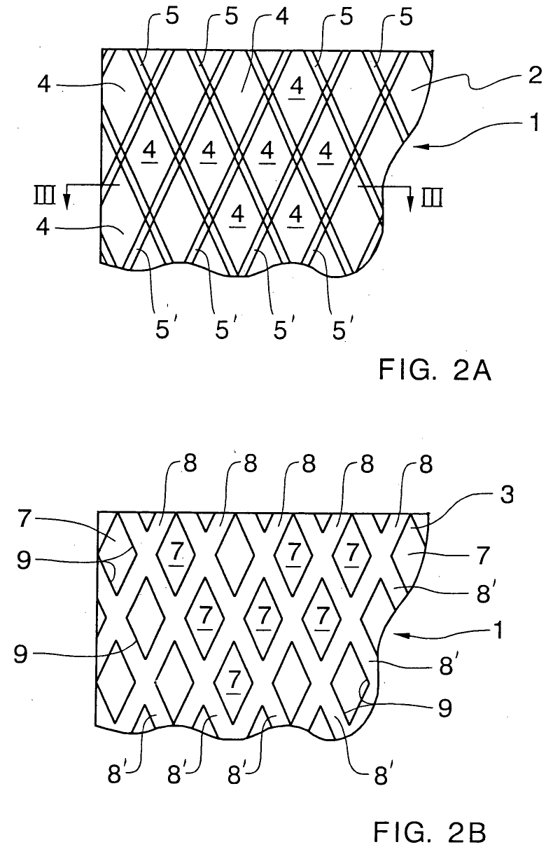

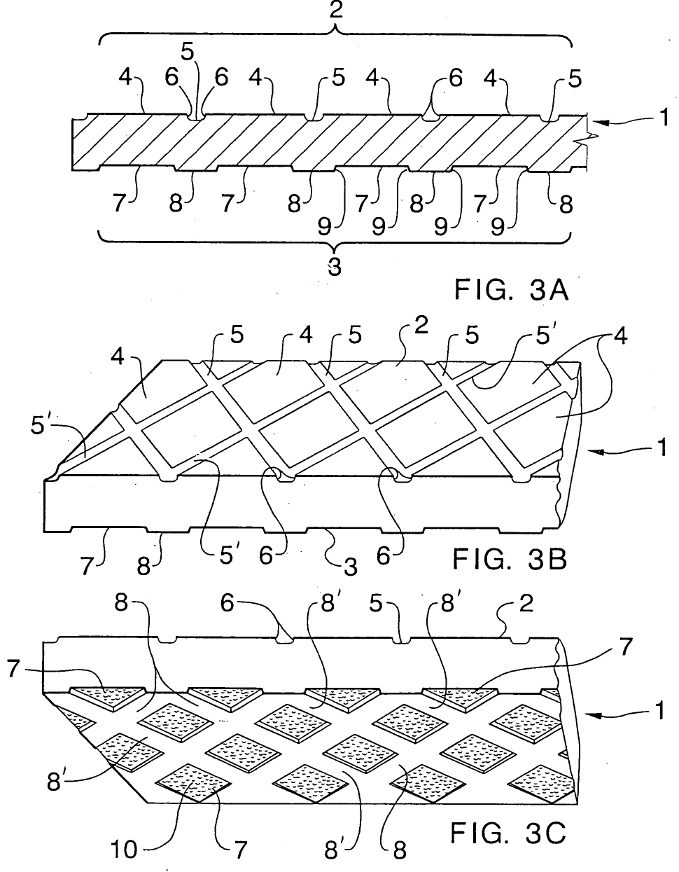

The food contacting surface 2, depicted in enlarged detail in FIGS. 2A, 3A and 3B, comprises a plurality of raised diamond-shaped surfaces 4 arrayed in a regularly spaced-apart pattern. The raised diamond-shaped surfaces 4 preferably lie in a common plane to define a food-contacting surface. Adjacent diamonds 4 are separated by spaced-apart sets of depressed grooves 5, 5′ having beveled edges 6 extending angularly upwardly from the opposed sides of the grooves 5, 5′ to the edges of the diamonds 4, as best seen in FIGS. 3A and 3B. The depressed grooves 5, 5′ are indented a depth of about 0.006 inch from the top surface of the diamonds 4 and are about 0.022 inch wide, for example. In the examples depicted in the appended drawings, the raised diamonds 4 are symmetrical about longitudinal and transverse axes. A first set of spaced-apart depressed grooves 5 is parallel in one direction and a second set of spaced-apart depressed grooves 5′ is parallel in a second direction, FIGS. 2A and 3B. The spacing between adjacent parallel depressed grooves of each of the sets of grooves 5, 5′ is about 0.127 inch, for example. The depressed grooves of the first and second sets of grooves 5 and 5′ intersect and converge at angles of about 50° and 130° to define the shape of the tips of the diamonds 4 in the presently preferred embodiment depicted in the drawings. The individual diamonds 4 are uniformly sized, for example, about 0.26 inch long by 0.1465 inch wide. The surface area of the raised diamond pattern 4 occupies about two-thirds of the baking surface area of the bakeware 1 while the depressed grooves 5, 5′ make up about one-third of that surface area. Other geometric shapes besides diamonds are, of course, possible, such as square shapes, for example. If a third set of parallel lines is added, regular triangles may be formed. It is an object of the invention that the raised surfaces of the food contacting surface be comprised of a plurality of straight-sided geometric shapes, separated by depressed sets of straight grooves for stick resistance and easy cleanup.

The above-described relationship of surface areas between the raised diamonds 4 and depressed grooves 5, 5′ is ideal in providing a baking surface which bakes and browns uniformly without burning the dough by virtue of air circulation along the depressed grooves 5, 5′. The sets of depressed grooves 5 and 5′ being straight and parallel, along with their angled or beveled edges 6, make clean-up very easy because there are no irregular surface pathways or vertical sharp grooves to trap food particles or to hinder the motion of cleaning pads. The present bakeware is easily cleaned simply by making straight line passes with a cleaning pad, for example, in the direction of each of the sets of grooves 5, 5′. In other words, in cleaning the bakeware of the present invention, there is no need to make a circular type of motion with an abrasive cleaning pad, which might otherwise scratch or mar the surface, as is sometimes necessary in prior art bakeware.

The raised diamond-shaped surfaces 4 of the textured bakeware 1 of the present invention resist scratching and marring, possibly due to the presence of the depressed grooves 5, 5′, even when a metal spatula or like utensil is scraped across the baking surface 2. The textured surface 2 presents a very attractive cosmetic appearance, particularly when combined with the textured exterior surface 3 of a complementary pattern which will be described next.

The exterior surface pattern 3 of the textured bakeware 1 of the present invention can best be understood with reference to FIGS. 1B, 2B, 3A and 3C. The exterior surface pattern 3 comprises a plurality of spaced-apart, depressed or indented diamond-shaped surfaces 7, separated by first and second sets of spaced-apart parallel raised ridges 8, 8′. The array of raised ridges 8, 8′ is similar to that of the sets of parallel depressed grooves 5, 5′ in that the first set of raised ridges 8 extend parallel in a first direction and the second set 8′ extend parallel to each other in a second direction and intersect with the first set of raised ridges 8. The depressed diamond-shaped surfaces 7 are indented below the raised ridges at a depth of about 0.006 inch. The edges of the depressed diamonds 7 have outwardly extending, beveled edges 9 which angularly meet the edges of the raised ridges 8. The depressed surfaces of the diamonds 7 are preferably roughened to lend a diffuse appearance quality thereto and contrast with the smooth surfaces of the adjacent raised ridges 8. This diffuse or roughened surface in the depressed diamonds 7 is formed by the embossing roll which carries a roughened surface on the roll protrusions forming the depressed diamonds 7.

By way of example, the indented diamond-shaped surfaces 7 may be about 0.2 inch long and about 0.0912 inch wide. In a presently preferred embodiment, the depressed diamond-shaped surfaces 7 occupy about 42% of the surface area of the exterior surface pattern 3. The raised ridges 8 represent substantially the balance, or about 58% of the surface area of the exterior surface pattern 3.

The textured bakeware 1 of the present invention is made from a metal sheet stock such as an aluminum alloy, preferably type 3003 aluminum, for its light weight, strength, corrosion resistance and formability. Aluminum is also a preferable material since it can be anodized. The flat aluminum sheet or strip stock is first rolled between a pair of textured rolls having a mating diamond pattern. In this manner, as the flat aluminum strip stock passes in the pressure of the roll bite, one of the rolls imparts the surface pattern 2 while the other roll imparts the surface pattern 3 to the opposed sides of the aluminum sheet or strip stock. As best seen in FIGS. 3A-3C, the respective raised and depressed diamonds 4 and 7 are in vertical register with one another, as are the depressed grooves 5 and raised ridges 8. In this manner, the cross-sectional thickness of the bakeware 1 remains constant to provide strength and uniform thermal expansion and contraction characteristics. Rolling textured aluminum metal sheet on both sides in this manner is known and is used, for example, in making kick plates for screen and storm doors.

As mentioned above, the double-sided textured surfaces of surface patterns 2 and 3 lend thermal stability to the bakeware 1, probably due to the uniform thickness and structural rigidity provided by this double-sided embossing. As a result, the bakeware 1 tends to maintain its flat planar shape when heated and cooled. This is particularly important in bakeware where a flat baking surface is desired. The thermal warping problems commonly experienced in flat bakeware, such as, for example, cookie sheets and jellyroll pans, to mention a few, are overcome by the bakeware 1 of the present invention.

In addition, besides enhancing the cosmetic appearance of the bakeware 1, the double-sided embossed textured surfaces 2 and 3 resist scratching, not only on the inside baking surface, as previously mentioned, but also on the exterior surface. The double-sided texturing also surprisingly makes the forming operation run more efficiently, due to the fact that the textured surfaces 2 and 3 seemingly retain a drawing lubricant more readily (on both surfaces) than would be the case with completely smooth sheet stock, or a sheet stock having only one side carrying a textured surface. The drawing operation proceeds more evenly and with less visible tool marks as a result of the textured surface patterns 2 and 3.

The double-sided texturing provided by the surfaces 2 and 3 also yields outside edges 11 of the bakeware 1 which are relatively smooth and substantially burr free. It is common in shearing the edges of smooth sheet stock (untextured) that a sharp outer edge will be present. This sharp edge can obviously cause a hazardous condition for the user. Thus, in such prior art bakeware, it is necessary to roll bead the outer edges to conceal the sharp edges thereof. This extra edge beading operation is not necessary in the double-sided textured bakeware 1 of the present invention.

A presently preferred sheet stock for forming the bakeware 1 of the present invention is an aluminum alloy such as type 3003 aluminum alloy having a thickness of about 0.063 inch. This material has been found to provide excellent rigidity, strength, good formability, corrosion resistance and light weight. The material may also be tempered for strength enhancement, such as an H-14 temper designation.

I have also discovered that the bakeware 1 of the present invention can be further enhanced in appearance, scratch resistance and heating characteristics by anodizing one or both sides. It is presently preferred to anodize both sides 2 and 3 due to the fact that it is easier than anodizing only one side, which requires sealing off one side of the bakeware from the anodizing solution. As alluded to above, anodizing provides a still more scratch- and mar-resistant surface because the anodized surface is harder than the base aluminum metal. A dark gray anodized color is preferred because of its heat absorbing characteristics and has an attractive cosmetic appearance, although a variety of other anodized colors are possible, if desired.

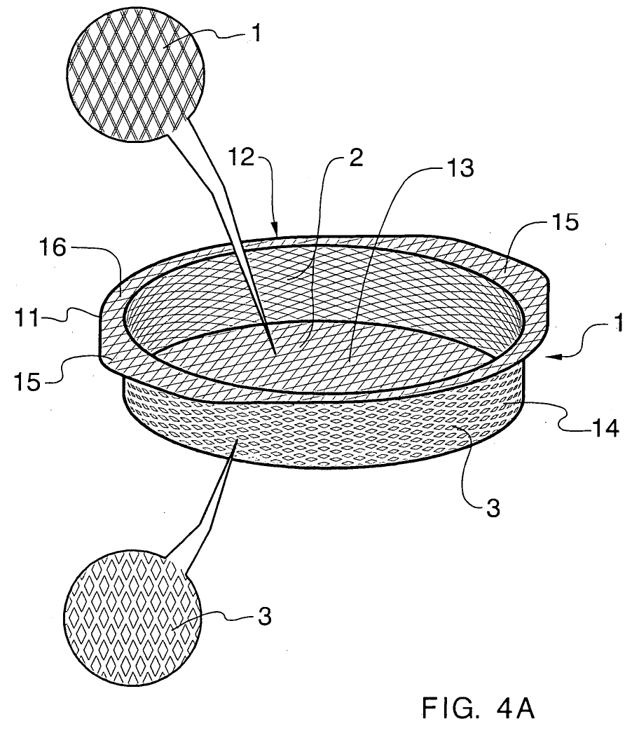

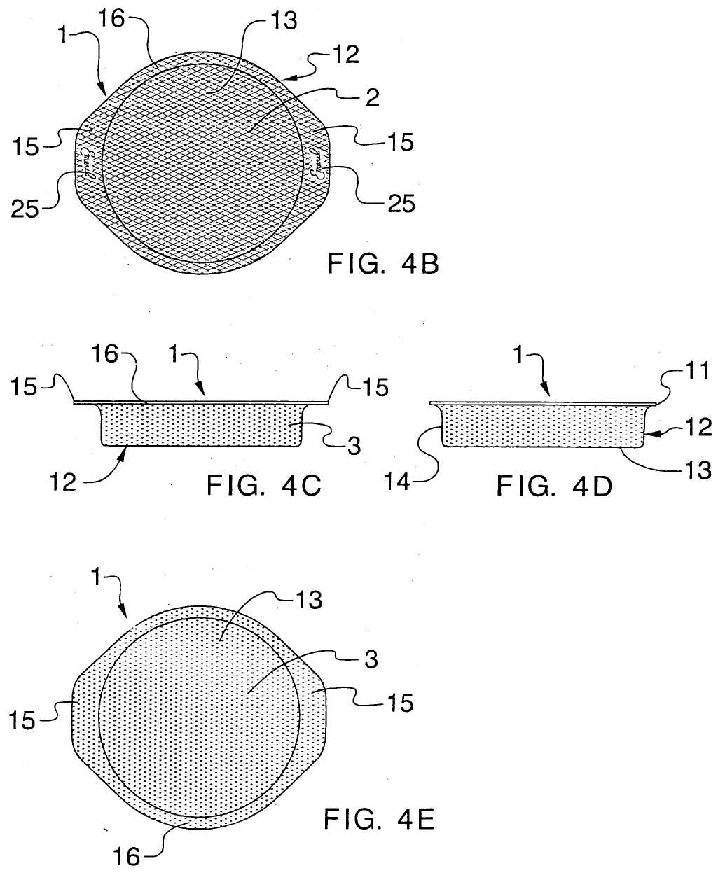

The bakeware 1 of the present invention can be configured in all of the most popular bakeware product configurations. FIGS. 4A-4E show the bakeware 1 in the form of a round cake pan 12, for example, a popular 9-inch round cake pan. It will be appreciated that the textured surfaces 1 and 3 are present on both the bottom 13 and sidewall 14 of the cake pan 12. Convenient handles 15 for gripping are also provided, integral with the top edge 16 of the pan 12. The flat handles 15 of the bakeware 1 provide a convenient flat, viewable surface for applying laser inscription indicia 25, if desired.

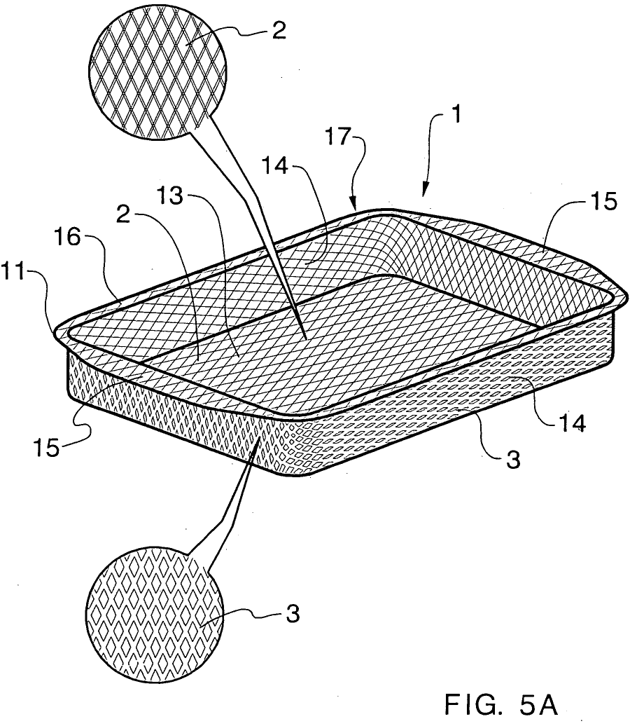

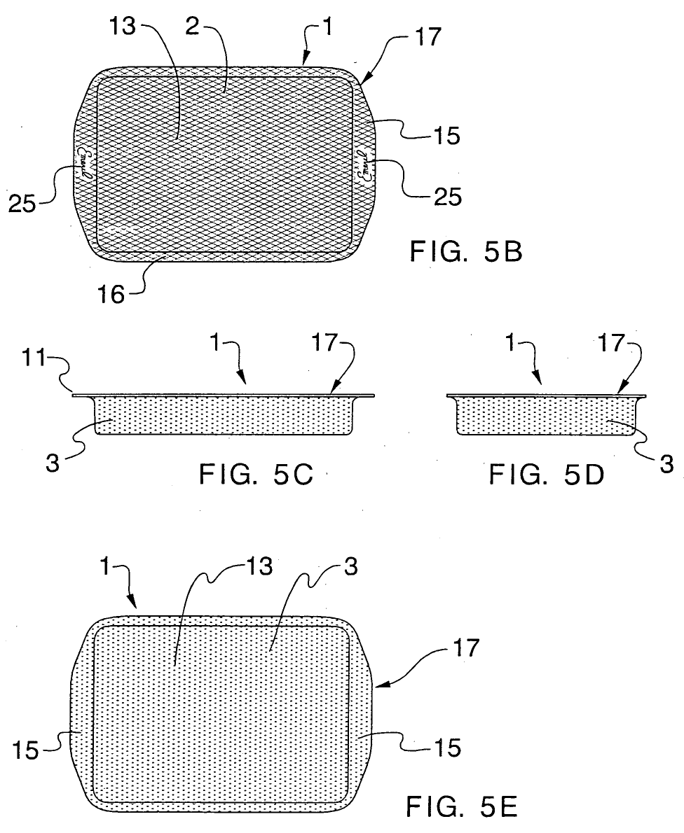

In a similar manner, the bakeware 1 of the present invention is configured as a popular rectangular 9×13 inch utility pan 17 in FIGS. 5A-5E. The pan 17 has the same structure as the previously described cake pan 12, namely, textured bottom 13 and sidewall 14 with integral handles 15.

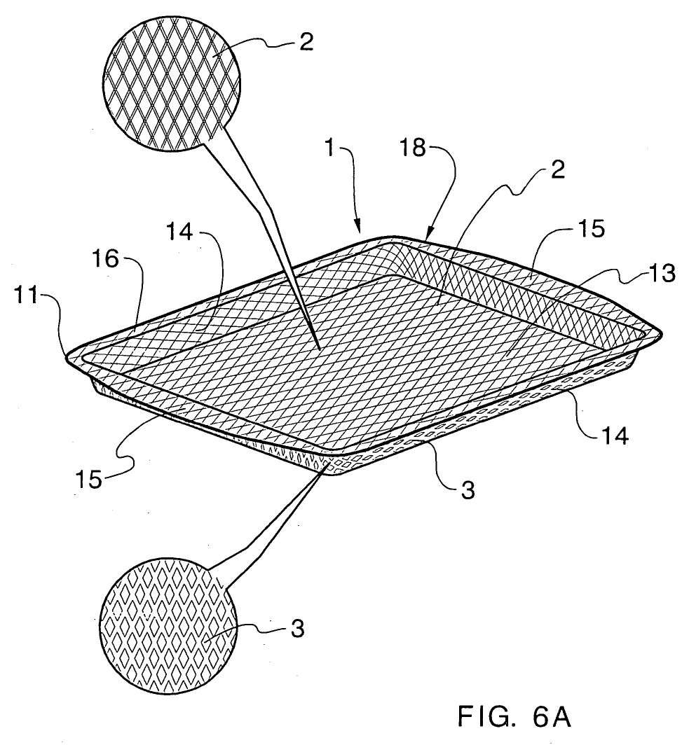

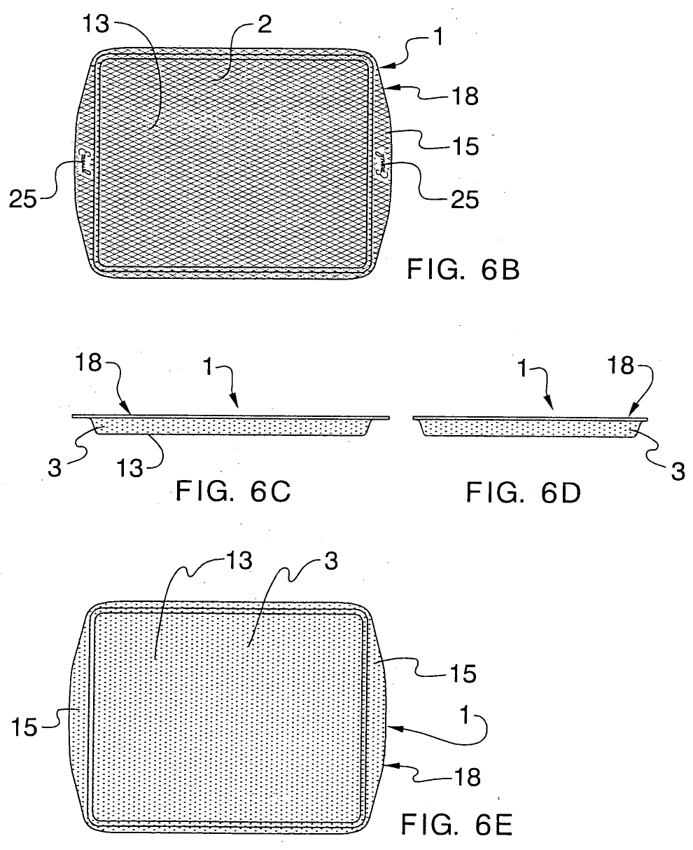

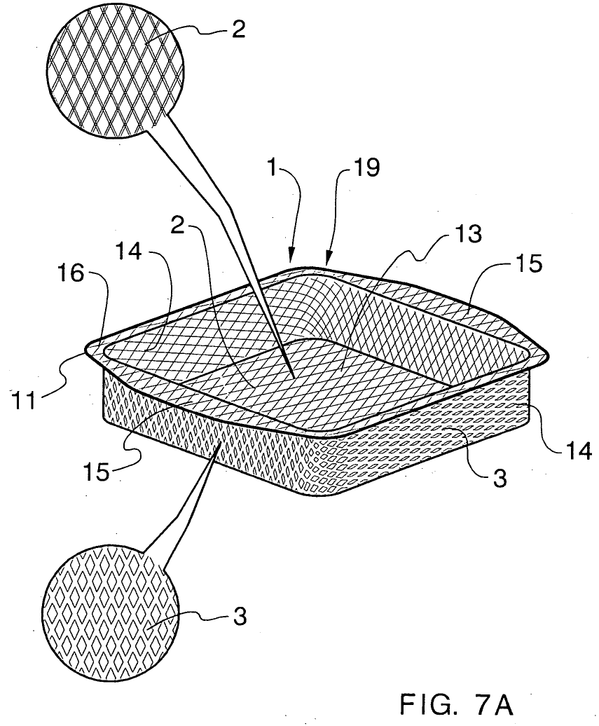

The bakeware 1 of FIGS. 6A-6E is in the form of a rectangular 13×18-inch jellyroll pan 18. The jellyroll pan 18 also has a textured bottom 13 and sidewall 14 with integral handles 15.

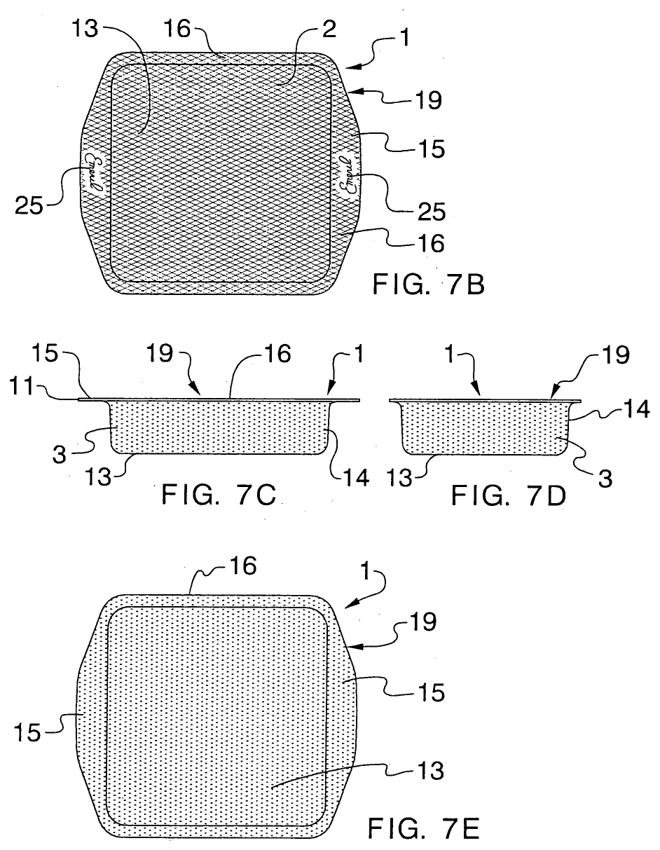

The bakeware 1 of FIGS. 7A-7E is in the shape of a square 8×8 inch cake pan 19 and includes the textured surface 2 and 3 on both the bottom 13 and sidewall 14 with handles 15.

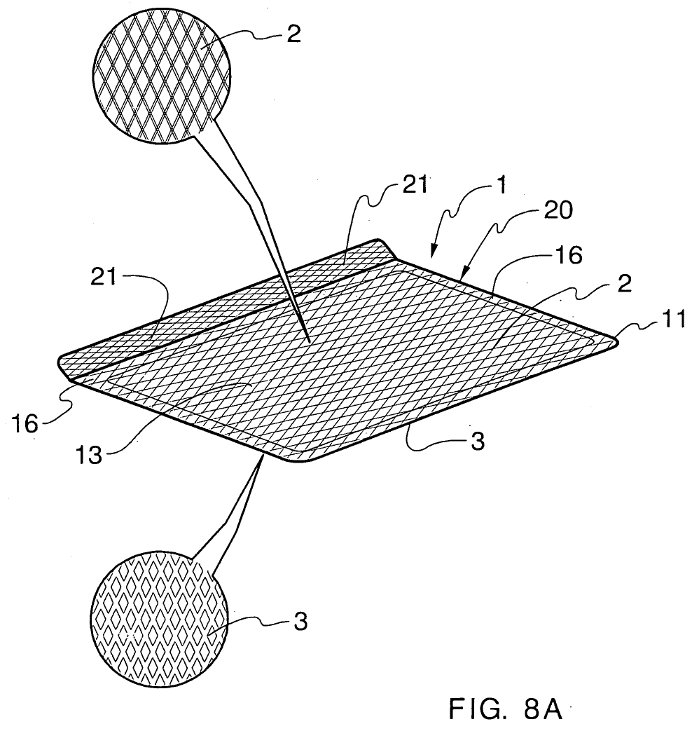

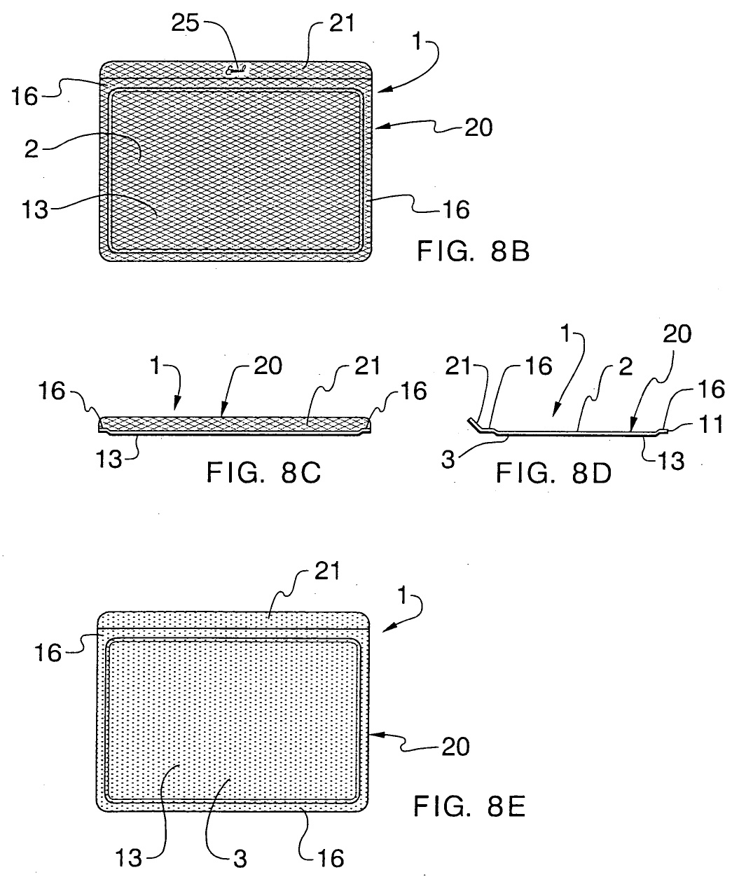

The bakeware 1 of FIGS. 8A-8A is a large cookie sheet 20 in a rectangular shape of, for example, 14×17 inches. The cookie sheet has a textured surface pattern 2 on the food contacting surface and the surface pattern 3 on the reverse side. The cookie sheet 20 is formed with a gripping edge 21 which is integral with the cookie sheet 20. The gripping edge 21 flares upwardly from the plane of surface 2 at a convenient angle for gripping.

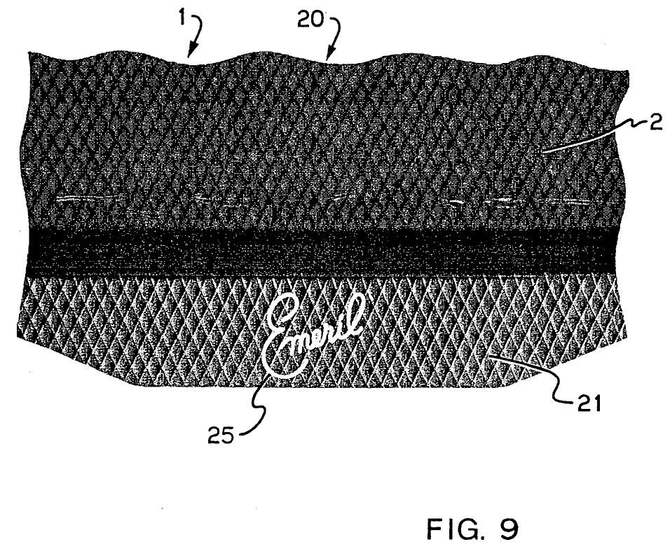

The color contrast provided by anodizing the surface 2 permits the placement of laser marking of indicia 25 of manufacture, endorsement or distributorship, for example, on the flat upper surface of the handles 15 of the baking pans 12, 17, 18 and 19 or on the flared edge 21 of the cookie sheet 20. Of course, other surfaces can be laser marked, such as on the bottom 13 on the exterior surface 3 thereof, or wherever desired. The laser scribes a white line on a gray anodized surface background, as depicted in FIG. 9, which is excellent in contrast, providing extremely readable indicia 25.

The food contacting surface 2 of the bakeware 1 may also have a PTFE layer such as a Teflon® brand non-stick layer applied thereto, if desired, to further enhance the non-stick characteristics of the bakeware. In two such presently preferred embodiments, the food contacting surface 2 carries a stick-resistant PTFE layer thereon while the exterior surface 3 is either anodized or un-anodized.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. Bakeware having a food contacting surface formed with an embossed textured pattern comprising a plurality of spaced-apart raised, straight sided geometric shapes separated by at least a first set of parallel depressed grooves and at least a second set of parallel grooves, wherein the first and second sets of depressed grooves intersect to define the raised geometric shapes therebetween.

2. The bakeware of claim 1 wherein the raised geometric shapes are selected from the group consisting of squares, diamonds and triangles.

3. The bakeware of claim 1 having an exterior surface formed with an embossed textured surface pattern.

4. The bakeware of claim 3 wherein the embossed exterior surface pattern comprising a plurality of spaced-apart, depressed, straight-sided geometric shapes separated by at least two sets of raised ridges, a first of said sets of raised ridges comprising a plurality of parallel extending ridges and a second set comprising a plurality of parallel extending ridges, wherein said first and second sets of ridges intersect with each other to define at least a portion of said straight sided geometric shapes.

5. The bakeware of claim 4 wherein the geometric shapes are diamond-shaped.

6. The bakeware of claim 4 including a third set of spaced-apart parallel raised ridges which intersect with the first and second sets of raised ridges to define the depressed geometric shapes as triangles.

7. The bakeware of claim 3 wherein at least one of the food contacting surface and the exterior surface is anodized.

8. The bakeware of claim 3 wherein the food contacting surface and the exterior surface are anodized.

9. The bakeware of claim 1 wherein the food contacting surface is coated with a non-stick layer.

10. The bakeware of claim 9 wherein the non-stick layer is a PTFE material and wherein the exterior surface is anodized.

11. The bakeware of claim 1 in a product configuration selected from the group consisting of a round cake pan, a round pie pan, a rectangular utility pan, a rectangular jellyroll pan, a square cake pan and a cookie sheet.

12. Bakeware having a food contact surface and an exterior surface, said food contacting surface formed with an embossed, textured pattern comprising a plurality of spaced-apart, raised diamond-shaped surfaces, said raised diamond-shaped surfaces separated by a first set of parallel depressed grooves and a second set of depressed parallel grooves which intersect with said first set to define the raised diamond-shaped surfaces therebetween;
said exterior surface comprising a plurality of spaced-apart depressed diamond-shaped surfaces separated by a plurality of first and second spaced-apart sets of parallel raised ridges wherein said first and second sets of raised ridges intersect to define the depressed diamond shaped surfaces therebetween.

13. The bakeware of claim 12 wherein at least one of the food contacting surface or the exterior surface is anodized.

14. The bakeware of claim 12 wherein both the food contacting and exterior surfaces are anodized.

15. The bakeware of claim 12 wherein the food-contacting surface has a stick resistance coating of a PTFE material applied thereon.

16. The bakeware of claim 15 wherein the exterior surface is anodized.

17. The bakeware of claim 12 having an anodized surface thereon and wherein laser applied indicia is engraved on said anodized surface.

18. The bakeware of claim 12 in a product configuration selected from the group consisting of a round cake pan, a round pie pan, a rectangular utility pan, a rectangular jellyroll pan, a square cake pan and a cookie sheet.

19. The bakeware of claim 12 wherein at least one of the food contacting surface or the exterior surface is anodized.

20. The bakeware of claim 12 wherein the food contacting surface is coated with a non-stick layer and the exterior surface is anodized.

21. The bakeware of claim 12 wherein both the food contacting surface and the exterior surface are anodized.
